(19) United States
(12) Patent Application Publication
(10) Pub. No.: US 2005/0153578 A1
(43) Pub. Date: Jul. 14, 2005

(54) Board mounted memory card connector

(76) Inventor: Tung-Chang Lin, WuKu Village (TW)

Correspondence Address: MOLEX INCORPORATED, 2222 WELLINGTON COURT, LISLE, IL, 60532, US

(21) Appl. No.: 11/010,740

(22) Filed: Dec. 13, 2004

(30) Foreign Application Priority Data
Dec. 12, 2003 (TW) 92221908

(51) Int. Cl. H01R 12/00

(52) U.S. Cl. 439/64

(57) ABSTRACT

A memory card connector is provided for mounting on a printed circuit board. The connector includes an insulating housing having a rear terminal-mounting section and at least one side wall section extending forwardly from one end of the rear section and combining therewith to define a card-receiving space. The housing includes at least one through hole. A fastening element is positionable on the housing and has a fastening hole in alignment with the through hole in the housing. A fastener extends through the circuit board, through the through hole in the housing and into the fastening hole in the fastening element to fix the insulating housing on the circuit board.

### FIELD OF THE INVENTION

This invention generally relates to the art of electrical connectors and, particularly, to a memory card connector for mounting on a printed circuit board.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smart phones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like. With circuit board mounted connectors, the terminals of a connector include tail portions which are connected to appropriate circuit traces on the printed circuit board by various systems, such as surface mount technology where the tail portions are reflow soldered to the circuit traces. Through hole technology involves inserting the tail portions of the terminals into the holes in the printed circuit board for connection, as by soldering, to circuit traces on the board and/or in the holes.

FIG. 1 shows a conventional board mounted memory card connector, generally designated 10, according to the prior art. Specifically, connector 10 includes an insulating housing 12 and a shielding cover 14 which combine to define a card-receiving space 16.for receiving a memory card inserted thereinto in the direction of arrow “A”. The housing/connector is mounted on a printed circuit board 18. A plurality of fastening pieces or flanges 20 project outwardly at various points about the periphery of the housing. The flanges hook onto shielding cover 14 or are secured to housing 12 by screws. A plurality of fastening elements 22, such as bolts, screws, or the like, extend through holes 24 in flanges 20 and are fixed to or through circuit board 18. It can be seen that fastening flanges 20 project outwardly from the circumference or profile of connector 10 (i.e., housing 12 and shielding cover 14).

With the ever-increasing miniaturization of electronic equipment and apparatus, memory cards and their respective connectors also are becoming more miniaturized. With fastening flanges 20 projecting outwardly form the circumference of prior art connector 10, problems are encountered on printed circuit board 18 because the outwardly projecting flanges interfere with adjacent electronic equipment, components or other connectors mounted on the circuit board. In other words, the outwardly projecting fastening flanges 20 take up too much “real estate” on the circuit board. In addition, it is difficult to secure fastening elements 22 to or through the circuit board. The present invention is directed to solving these problems.

### SUMMARY OF THE INVENTION

An object, therefore, of the invention is to provide a new and improved memory card connector for mounting on a printed circuit board.

In the exemplary embodiment of the invention, the connector includes an insulating housing having a rear terminal-mounting section and at least one side wall section extending forwardly from one end of the rear section and combining therewith to define a card-receiving space. The housing includes at least one through hole. A fastening element is positionable on the housing and has a fastening hole in alignment with the through hole in the housing. A fastener extends through the circuit board, through the through hole in the housing and into the fastening hole in the fastening element to fix the insulating housing on the circuit board.

According to one aspect of the invention, the insulating housing is generally U-shaped and includes a pair of the side walls sections extending forwardly from opposite ends of the rear section of the housing. One of the through holes is formed in each side wall section. A pair of through holes are formed at opposite ends of the elongated rear section. Each of the plurality of through holes receives one of the fasteners, along with one of the fastening elements for each fastener.

According to another aspect of the invention, the housing includes a recess in the top thereof about each through hole for receiving the respective fastening element. The recess has a depth at least equal to a thickness of the fastening element so that the fastening element does not project upwardly beyond a top surface of the housing. A metal shield is mounted onto the top surface of the housing without interference by the fastening element. The recess and the fastening element have non-circular configurations relative to an axis of the respective through hole to prevent rotation of the fastening element relative to the housing about the axis.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the FIGS. and in which:

FIG. 1 is a top plan view of a prior art connector mounted on a printed circuit board according to the prior art and as described in the Background, above;

FIG. 2 is an exploded perspective view of a memory card connector according to the invention, in conjunction with a printed circuit board;

FIG. 3 is a perspective view of the connector of FIG. 2 in assembled condition and mounted onto the circuit board;

FIG. 4 is a top plan view of the connector on the circuit board;

FIG. 5 is a vertical section taken generally along line 5-5 in FIG. 4; and

FIG. 6 is a vertical section taken generally along line 6-6 in FIG. 4.

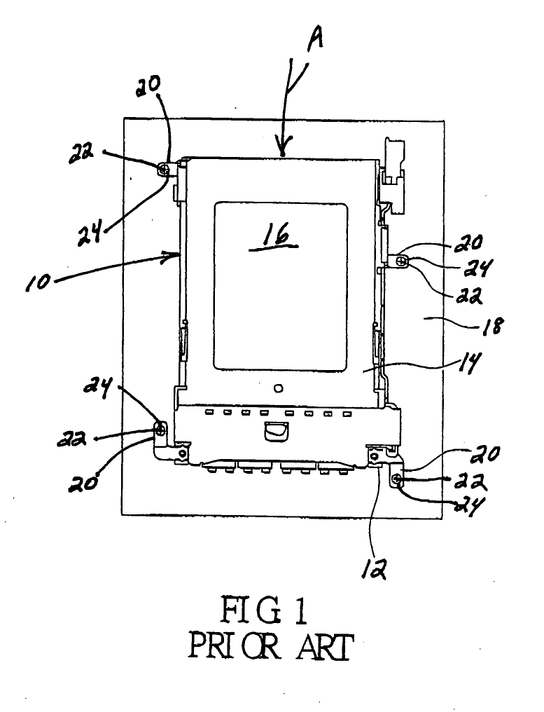

### DETAILED DESCRIPTION OF THE PREFERRED EMBODIMENTS

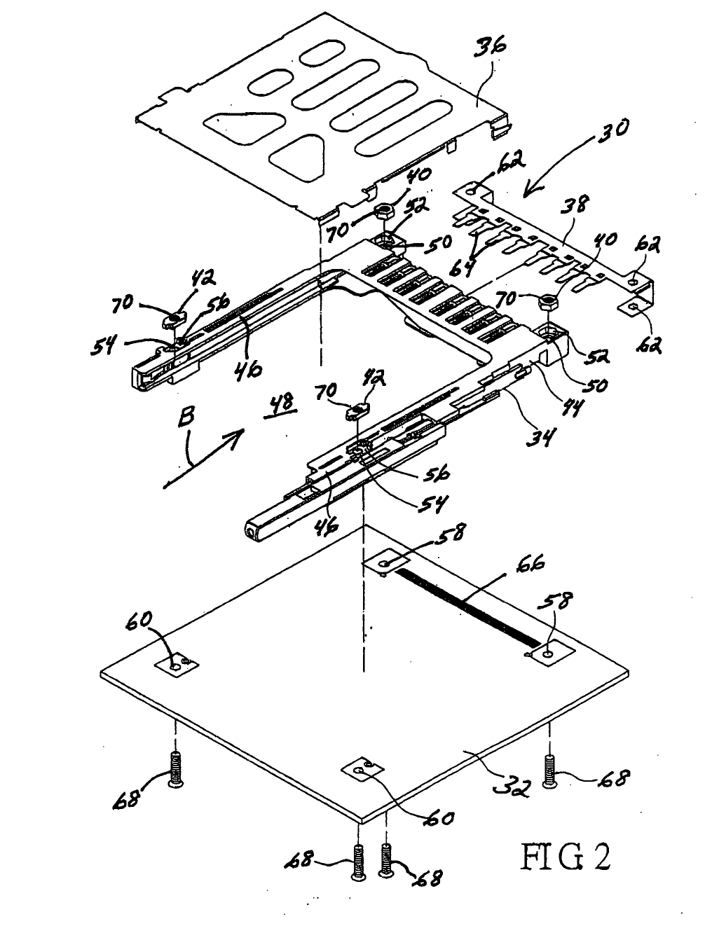

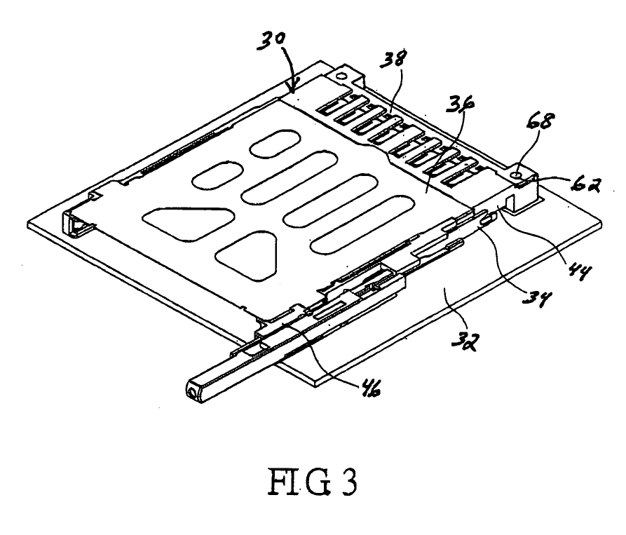

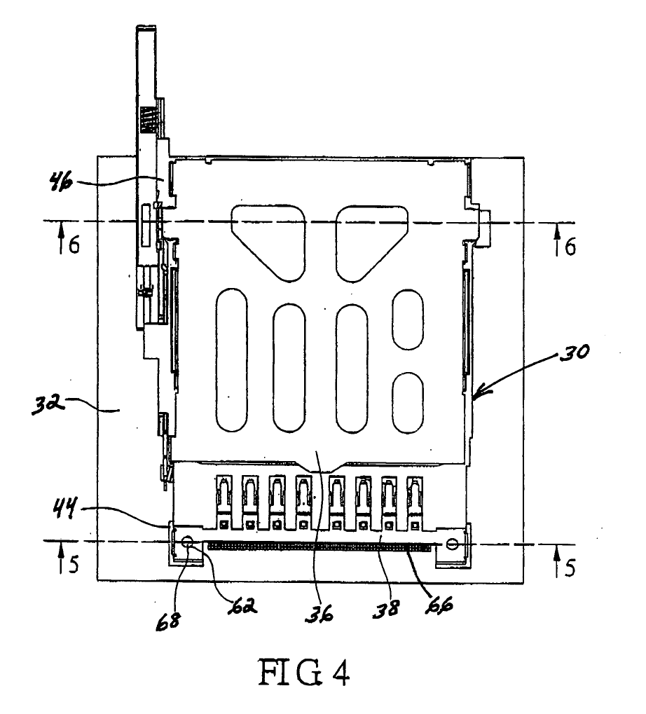

Referring to the drawings in greater detail, and first to FIGS. 2-4, the invention is embodied in a memory card connector, generally designated 30, for mounting on a printed circuit board 32. Generally, the connector includes an insulating housing 34, a shielding cover 36, a rear shielding bracket 38 and a plurality of fastening elements 40 and 42.

Housing 34 of connector 30 is generally U-shaped and includes an elongated rear terminal-mounting section 44 and a pair of side wall sections 46 extending forwardly from opposite ends of the rear section and combining therewith to define a card-receiving space for receiving a memory card inserted thereinto in the direction of arrow “B”. A through hole 50 is formed vertically through the housing at each rear corner of rear section 44 of the housing. A recess 52 is formed in the top of the housing about each through hole 50. A through hole 54 is formed vertically through each side wall section 46 of the housing. A recess 56 is formed in the top surface of each side wall section about each through hole 54. When housing 34 is mounted onto circuit board 32, through holes 50 at the rear of the housing are aligned with a pair of mounting holes 58 (FIG. 2) in the circuit board. Through holes 54 in side wall sections 46 of the housing are aligned with a pair of mounting holes 60 in the circuit board.

Rear shielding bracket 38 is elongated and is positioned over the elongated rear terminal-mounting section of the housing. The bracket includes a plurality of through holes 62 which are alignable with through holes 50 in the housing to fixed the bracket thereto, as will be seen hereinafter. The bracket has a plurality of fingers 64 which shield a plurality of terminals mounted in the rear terminal-mounting section 44 of the housing. As is known, the terminals have tail portions for connection, as by soldering, to a plurality of circuit traces 66 on the printed circuit board.

All of fastening elements 40/42 and recesses 52/56 have non-circular configurations relative to the vertical axes of through holes 50/54. This prevents rotation of the fastening elements relative to the housing about the axes of the through holes. Specifically, fastening elements 40 and their respective recesses 52 are hexagonal in configuration, with the recesses being slightly larger than the fastening elements so that the fastening elements simply are deposited into the recesses. Fastening elements 42 and their respective recesses 56 are elongated in configurations to prevent rotation of the fastening elements within their recesses. In addition, the depths of at least recesses 56 are equal to the thicknesses of fastening elements 42 so that the fastening elements do not project upwardly beyond the top surfaces of side wall sections 46 to avoid interference with shielding cover 36 which is generally planar and which is mounted flush with the top surface of housing 34.

Connector 30 is mounted onto circuit board 32 by means of a plurality of fasteners 68 which extend upwardly through mounting holes 58 and 60 in the circuit board, upwardly through holes 50 and 54 in housing 34 and into through holes 70 in fastening elements 40 and 42. The fasteners which extend upwardly through mounting holes 58 in the circuit board and through holes 50 in the housing also extend through holes 62 in the rear shielding bracket 38 to fix the bracket in position. Fasteners 68 herein are in the form of externally threaded elements such as bolts, screws or the like, and holes 70 in fastening elements 40 and 42 are internally threaded holes.

FIG. 5 shows a pair of the fasteners 68 extending upwardly through mounting holes 58 in circuit board 32, through holes 50 in the housing as well as holes 62 in rear shielding bracket 38, and into holes 70 in fastening elements 40. The housing is drawn tightly onto the circuit board and fixed thereto by rotating the externally threaded fasteners 68 and screwing the fasteners into fastening elements 40 which are captured within recesses 52 (FIG. 2). Shielding cover 36 then is mounted over the top of housing 34.

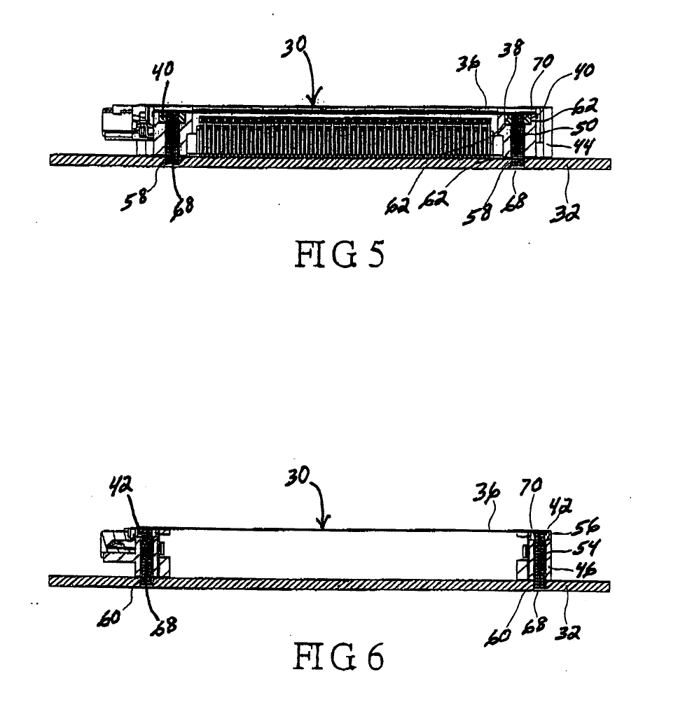

FIG. 6 shows a pair of the fasteners 68 extending upwardly through mounting holes 60 in circuit board 32 and through holes 54 in side wall sections 46 of the housing. The externally threaded fasteners are rotated and threaded into fastening elements 42 which are disposed in their respective recesses 56 in the top surfaces of the side wall sections. It can be seen in FIG. 6 that fastening elements 42 do not project upwardly beyond the top surface of the housing.

It can be seen in FIGS. 5 and 6 that mounting holes 58 and 60 in circuit board 32 are countersunk about the bottoms thereof so that the heads of fasteners 68 are at least flush with the bottom surface of the circuit board.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector for mounting on a printed circuit board, comprising:
an insulating housing having a rear terminal-mounting section and at least one side wall section extending forwardly from one end of the rear section and combining therewith to define a card-receiving space, the housing including at least one through hole;
a fastening element positionable on the housing and having a fastening hole in alignment with the through hole in the housing; and
a fastener extending through the circuit board, through the through hole in the housing and into the fastening hole in the fastening element to fix the insulating housing on the circuit board.

2. The memory card connector of claim 1 wherein said through hole is in the rear section of the housing.

3. The memory card connector of claim 2 wherein said rear section of the housing is elongated and includes opposite ends with one of said through holes in each opposite end for receiving therethrough one of said fasteners, along with one of said fastening elements for each fastener.

4. The memory card connector of claim 1 wherein said through hole is in the side wall section of the housing.

5. The memory card connector of claim 1, including a pair of said side wall sections extending forwardly from opposite ends of the rear section of the housing with one of said through holes in each side wall section for receiving therethrough one of said fasteners, along with one of said fastening elements for each fastener.

6. The memory card connector of claim 5 wherein said rear section of the housing is elongated and includes opposite ends with one of said through holes in each opposite end for receiving therethrough one of said fasteners, along with one of said fastening elements for each fastener.

7. The memory card connector of claim 1 wherein said housing includes a recess in the top thereof about the through hole for receiving the fastening element.

8. The memory card connector of claim 7 wherein said recess has a depth at least equal to a thickness of the fastening element so that the fastening element does not project upwardly beyond a top surface of the housing.

9. The memory card connector of claim 8, including a metal shield mounted onto the top surface of the housing.

10. The memory card connector of claim 7 wherein said recess and said fastening element have non-circular configurations relative to an axis of said through hole to prevent rotation of the fastening element relative to the housing about the axis.

11. A memory card connector for mounting on a printed circuit board, comprising:
a generally U-shaped insulating housing having an elongated rear terminal-mounting section and a pair of side wall sections extending forwardly from opposite ends of the rear section and combining therewith to define a card-receiving space, the housing including a plurality of through holes, two of said through holes being located at opposite ends of the elongated rear section and one of the through holes being located in each side wall section, and a recess in a top surface of the housing about at least some of the through holes;
a fastening element positionable on the housing for each through hole therein and having a fastening hole in alignment with the respective through hole; and
a plurality of fasteners extending through the circuit board, through the through holes in the housing and into the fastening holes in the fastening elements to fix the insulating housing on the circuit board.

12. The memory card connector of claim 11 wherein said recesses have depths at least equal to thicknesses of the respective fastening elements in the recesses, whereby the fastening elements do not project upwardly beyond a top surface of the housing.

13. The memory card connector of claim 12, including a metal shield mounted onto the top surface of the housing.

14. The memory card connector of claim 11 wherein said recesses and said fastening elements have non-circular configurations relative to axes of the respective through holes to prevent rotation of the fastening elements relative to the housing about the axis.
